(19) United States
(12) Patent Application Publication
(10) Pub. No.: US 2009/0285280 A1
(43) Pub. Date: Nov. 19, 2009

(54) Method and Apparatus for Securing Digital Content

(76) Inventors: Thomas Patrick Newberry, Westfield, IN (US); David John Weaver, Fisher, IN (US); Ronald Douglas Johnson, Westfield, IN (US)

Correspondence Address: Thomson Licensing LLC, P.O. Box 5312, Two Independence Way, PRINCETON, NJ, 08543-5312, US

(21) Appl. No.: 12/084,658

(22) PCT Filed: Jun. 22, 2006
(86) PCT No.: PCT/US2006/024039

§ 371 Date: May 7, 2008

Related U.S. Application Data
(60) Provisional application No. 60/740,463, filed on Nov. 29, 2005.

(51) Int. Cl. H04N 7/12

(52) U.S. Cl. 375/240.01; 375/E07.076

(57) ABSTRACT

A video processing apparatus, including: power-up circuitry; an input for receiving encoded video signals; a memory having stored therein processing instructions for processing the encoded video signals to provide an output signal; a decoder, coupled to the input, for processing the received encoded video signals in accordance with the processing instructions; a first controller, coupled to the memory and decoder, for controlling operation of the decoder to process the encoded video signals in accordance with the processing instructions; and a second controller, coupled to the first controller, memory and power up circuitry, wherein, the second controller in response to a start up procedure restricts operation of the first controller and validates the processing instructions, and upon validation of the processing instructions un-restricts operation of the first controller thereby allowing the controller to read the processing instructions from the memory.

### FIELD OF THE INVENTION

The present invention relates generally to digital content delivery systems, and more particularly to an apparatus and a method for receiving and decoding video signals.

### BACKGROUND OF THE INVENTION

FIG. 1 shows a conventional digital video processing architecture 10, which may be embodied in, for example, a digital set top box (STB) or a television. Architecture 10 includes a processor 20 along with non-volatile memory 30 (e.g., a bootROM, or flash memory) and dynamic memory 35 for software. “Processor”, as used herein, refers generally to a computing device including a Central Processing Unit (CPU), such as a microprocessor. A CPU generally includes an arithmetic logic unit (ALU), which performs arithmetic and logical operations, and a control unit, which extracts instructions (e.g., a computer program incorporating code) from memory and decodes and executes the instructions, calling on the ALU when necessary. “Memory”, as used herein, refers generally to one or more devices capable of storing data, such as in the form of chips, tapes, disks or drives. Memory may take the form of one or more random-access memory (RAM), read-only memory (ROM), programmable read-only memory (PROM), erasable programmable read-only memory (EPROM), or electrically erasable programmable read-only memory (EEPROM) chips, by way of example only. Memory may be internal or external to an integrated unit, e.g. an integrated circuit (IC), including a processor.

In normal operation, digital content is received using input 40. Input 40 may take the form of a satellite receiver, Internet Protocol (IP) receiver or digital cable television receiver, for example. The received content is decoded using decoder 50 responsively to processor 20 executing software instructions accessed via memory bus 25. Power-up and reset circuitry 60 is used to operate, boot and/or re-boot architecture 10 in a conventional manner. Such an architecture is well understood to those possessing an ordinary skill in the pertinent arts.

One drawback of architecture 10 of FIG. 1 is its susceptibility to tampering, or hacking, of the software that controls the operation of the processor. For example, a hacker can replace the original equipment manufacturer's (OEMs) or other authorized software, such as processor executable code being stored in memory 30 and/or 35, with unauthorized, or modified software, for the purposes of copying or stealing digital content or for other illegal or unauthorized purposes.

Accordingly, it is desirable to provide a method and apparatus that can detect whether hackers or pirates have replaced a set-top box's core software with their own or modified software, and prevent or impede operation of the apparatus when hacking is detected in order to prevent unauthorized capture or viewing of digital content.

### SUMMARY OF THE INVENTION

A video processing apparatus, including: power-up circuitry; an input for receiving encoded video signals; a memory having stored therein processing instructions for processing the encoded video signals to provide an output signal; a decoder, coupled to the input, for processing the received encoded video signals in accordance with the processing instructions; a first controller, coupled to the memory and decoder, for controlling operation of the decoder to process the encoded video signals in accordance with the processing instructions; and a second controller, coupled to the first controller, memory and power up circuitry, wherein, the second controller in response to a start up procedure restricts operation of the first controller and validates the processing instructions, and upon validation of the processing instructions un-restricts operation of the first controller thereby allowing the controller to read the processing instructions from the memory.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts and in which:

FIG. 1 illustrates a block diagram of a conventional digital set-top box (STB) architecture;

FIG. 2 illustrates a block diagram of a digital set-top box (STB) architecture according to an embodiment of the present invention;

FIG. 3 is a simplified flow diagram depicting a general process flow associated with the secure processor, main processor and memory in accordance with the principles of the invention;

FIG. 4 illustrates a flow diagram of Step 1 of FIG. 3;

FIG. 5 illustrates a flow diagram of Step 2 of FIG. 3; and,

FIG. 6 illustrates a flow diagram of Step 3 of FIG. 3.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements found in typical decoding methods and systems. However, because such elements are well known in the art, a discussion of such elements is not provided herein. The disclosure herein is directed to all such variations and modifications known to those skilled in the art.

In one embodiment of the present invention, when a digital set-top box is booted or re-booted, a secure processor performs a start-up validation procedure for restricting operation of the set-top box main processor. In one configuration, the secure processor performs this function by activating a reset input of the main processor. The secure processor performs validation of software contained in memory to verify the software has not been modified. The software may control the operation of the main processor and/or the decoder. Upon validation, the secure processor releases the reset input of the main processor—thereby freeing the main processor to begin or resume normal boot or startup operations. In this manner the apparatus according to the present invention verifies the integrity of the software before the software is loaded into the main processor.

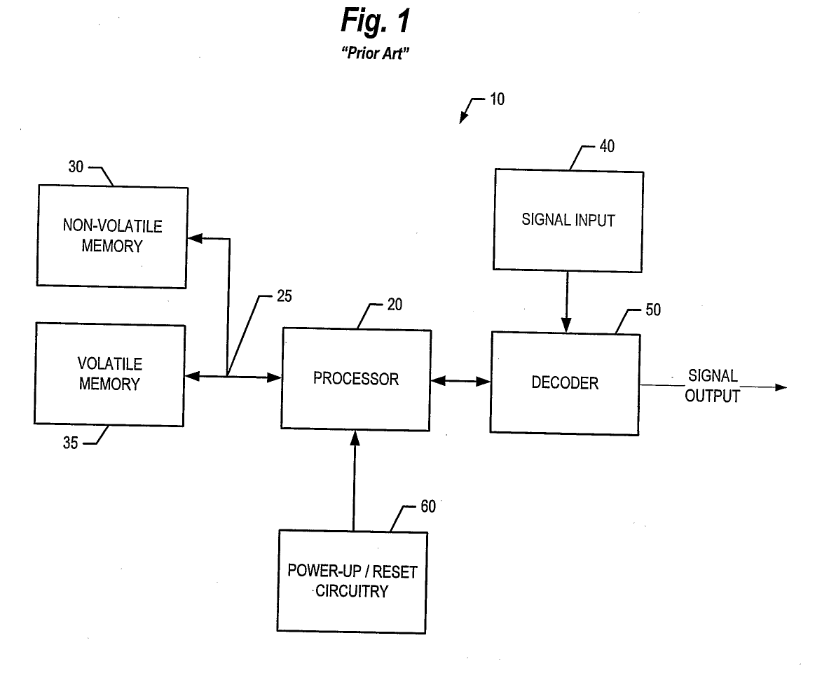

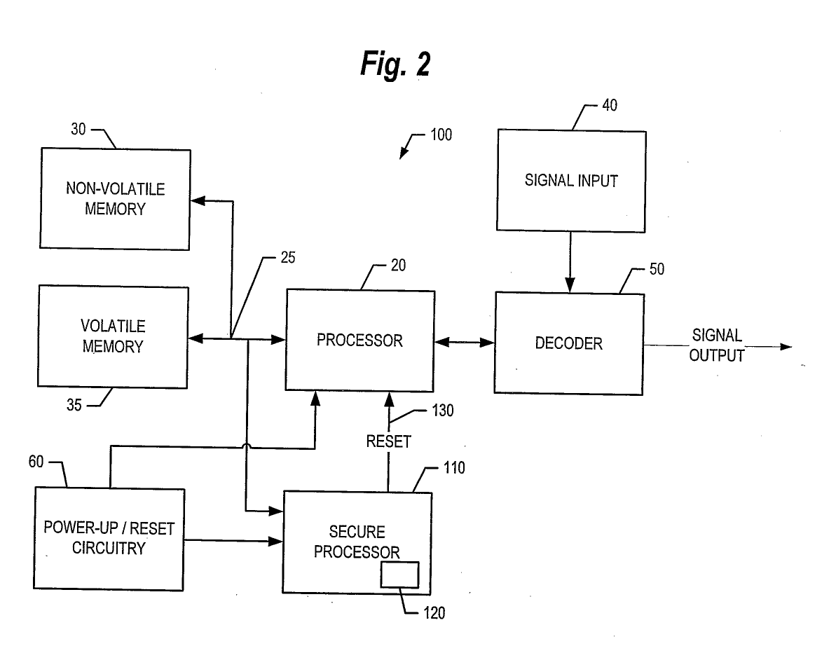

FIG. 2 shows a digital content receiver architecture 100 according to an embodiment of the present invention. Architecture 100 may be embodied as a set-top box analogous to that of FIG. 1. Like elements in architectures 10 and 100 have been labeled using like references. Architecture 100 additionally includes a secure processor 110 with embedded memory and software 120. Secure processor 110 may take the form of a secure microprocessor, or microprocessor incorporating integrated circuit (IC) for example. Processors 20, 110 may be embedded within a common integrated circuit, for example.

In operation, secure processor 110 controls, or restricts, the processor 20 boot-up process via the reset input 130. Before processor 20 is permitted to boot-up, secure processor 110 validates the on-board software, e.g., software stored in memory 30 and/or 35, to ensure that it has not been tampered with or replaced. Secure processor 110 can provide other secure features as well, such as decrypting on-board software and/or received digital content, and managing and storing content related keys, for example. Additionally, if a hacker removes or otherwise disables secure processor 110, then the secure processor 110 memory 120 stored keys are no longer available to decrypt, descramble or otherwise access digital content received via input 40.

In one embodiment of the invention, secure processor 110 may take the form of part no. AT97SC3201, which is a commercially available integrated circuit (IC) from Atmel Corporation of San Jose, Calif.

Referring still to FIG. 2, secure processor 110 has an output coupled to the reset input 130 of processor 20. Thus, processor 110 can reset, and/or inhibit booting or re-booting of processor 20 by activating reset input 130. For example, the secure processor 110 may set the processor 20 reset input by default, until validation occurs. Thus, upon power being applied, e.g., a power-up, or upon a system reset, e.g., a start or restart condition being detected, the secure processor 110 will inhibit processor 20 booting until it has booted and validated the software and/or data of interest.

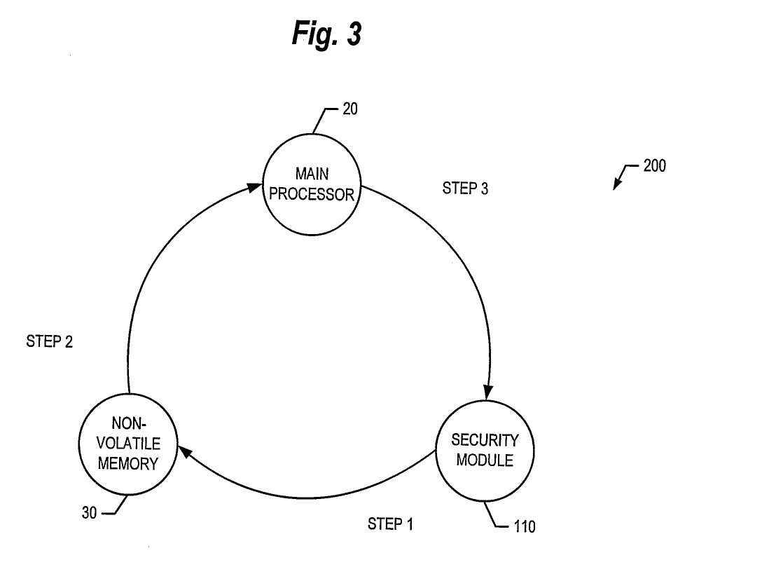

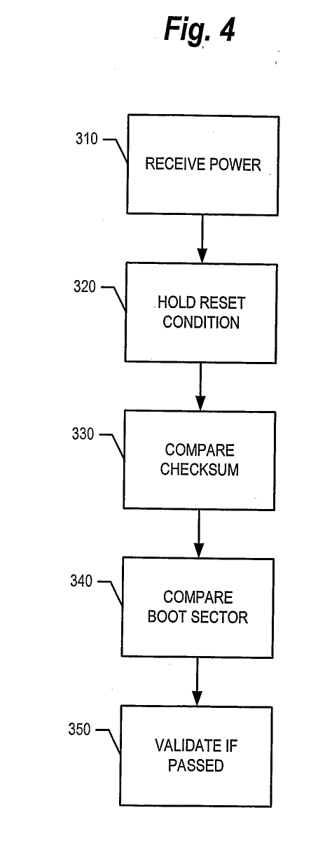

Referring now also to FIG. 3, there is shown a block diagram 200 according to an embodiment of the present invention. Block diagram 200 will be discussed as it relates to architecture 100 for non-limiting purposes of explanation and with respect to the processing operations depicted in FIGS. 4, 5 and 6. Referring now also to FIG. 4, at step 1 of FIG. 3, the architecture 100 receives power via power-up circuit 60 (FIG. 2). In an exemplary embodiment this step occurs when a set-top box is turned on or otherwise activated. In response to receipt of the activation signal, secure processor 110 holds or maintains the main processor 20 in a reset condition (step 320), such as by activating the reset input 130 of processor 20.

In one embodiment, secure processor 110 compares the checksum within the non-volatile memory 30, e.g., bootROM, against a checksum internally stored, e.g., in memory 120 at step 330. By way of non-limiting example, a checksum may be generated by adding up the basic components of data, typically the asserted bits, and storing the resulting value. The authentic checksum may be stored in memory 120. Secure processor 120 may independently calculate the checksum and compare the result to the authentic checksum to conclude that the code was not altered or replaced.

At step 340 secure processor 110 compares the boot sector of the non-volatile memory 30, e.g., bootROM, against a boot sector internally stored, e.g., in memory 120. By way of further non-limiting explanation, a boot sector is a sector of a memory that contains code for bootstrapping, or booting, programs.

If the compare results for each of process blocks 330, 340 yield a proper match (e.g. no discrepancies between the compared results exist), the architecture 100 is validated at step 350. If validated, processing proceeds to step 2. If not validated, then the architecture is rebooted, which will re-initiate step 1. Processor executable code, e.g., software, for accomplishing steps 320, 330, 340, 350 may be stored in memory 120.

By way of further non-limiting example only, the validation may be based upon public key, or asymmetric key cryptography. Public key cryptography is a form of cryptography which generally allows users to communicate securely without having prior access to a shared secret key. This may be accomplished by using a pair of cryptographic keys, designated as a public key and private key, which are related mathematically. In public key cryptography, the private key is kept secret, while the public key may be widely distributed. Generally, it is not feasible to deduce the private key of a pair given the public key. For example, a private key may be embedded within memory 120 of secure processor 110. At least a portion of the software to be validated may be encrypted and stored in memory 30/35 using a corresponding public key, such that secure processor 110 may decrypt and validate it. Alternatively, a symmetric key may be used.

Alternatively, or in addition thereto, processor 110 may check for watermarks on or in code stored in memory 30 and/or 35 to validate architecture 100. Digital watermarking is a technique which allows for hidden verification data to be inserted into underlying data. Such hidden verification data may take the form of a predetermined group of bits. In such an embodiment, a digital watermark may be embedded in the software to be validated in a conventional manner, such that secure processor 110 may later confirm the presence of the watermark and validate the software.

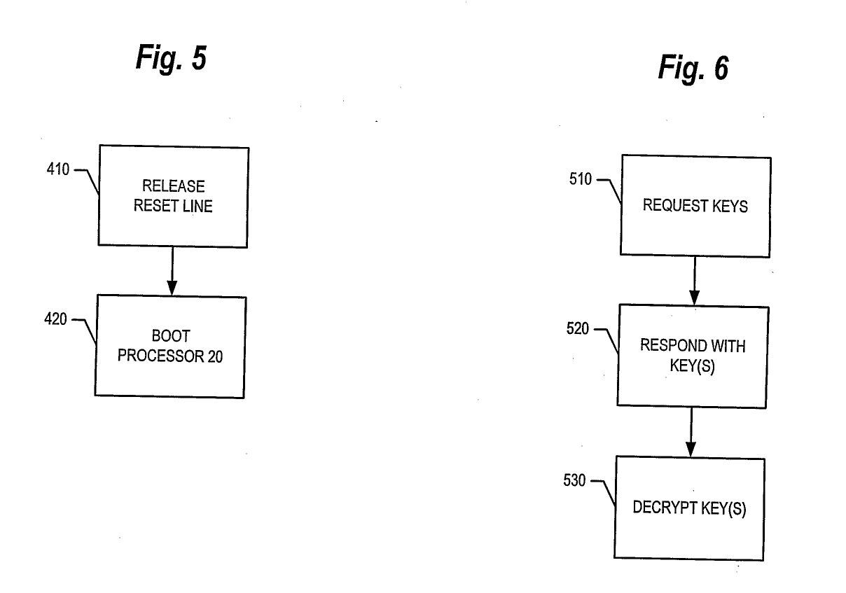

Referring now also to FIG. 5 in conjunction with FIGS. 2 and 3, in step 2 (FIG. 3) secure processor 110 releases the processor 20 reset input 130 (step 410 of FIG. 5). Responsively thereto, processor 20 boots from the non-volatile memory 30, (e.g., bootROM) at step 420. Secure processor executable code, e.g., software, for accomplishing step 410 may be stored in memory 120.

Referring now also to FIG. 6 in conjunction with FIGS. 2 and 3, in step 3 (FIG. 3) processor 20 requests decryption keys from the security processor 110 in step 510. Secure processor 110 responds with the requested keys at step 520. For example, the secure processor 110 may pass decrypt keys which are encrypted with one or more private keys associated with the secure processor 110. At step 530, processor 20 decrypts the encrypted keys using locally stored public key(s) corresponding to the secure processor 110 private key(s). Processor executable code, e.g., software, for accomplishing steps 510, 530 may be stored in memory 30 and/or 35. Secure processor executable code, e.g., software, for accomplishing step 520 may be stored in memory 120.

Upon completion of these steps, architecture 100 has successfully performed a secure boot as well as decrypted (securely) one or more keys for security usage, e.g., to-access digital-content received via-input 40. This approach minimizes hacking and malicious spoofing.

Additional steps can be taken to further increase the secure nature of the boot process and handling of keys, however these three steps form the basis of the overall approach. Such additional processing may include sampling select portions of software stored in memory 30/35, and storing data indicative of the samples in memory 120, such that secure processor 110 may later re-sample and validate the stored software. Similarly, function pointers may be validated and/or a checksum of portions, or all, of the software image may be compared, for example.

It will be apparent to those skilled in the art that modifications and variations may be made in the apparatus and process of the present invention without departing from the spirit or scope of the invention. It is intended that the present invention cover the modification and variations of this invention provided they come within the scope of the appended claims and their equivalents.

1. A video processing apparatus, comprising:
power-up circuitry;
an input for receiving encoded video signals;
a memory having stored therein processing instructions for processing the encoded video signals to provide an output signal;
a decoder, coupled to the input, for processing the received encoded video signals;
a first controller, coupled to the memory and decoder, for controlling operation of the decoder to process the encoded video signals in accordance with the processing instructions; and
a second controller, coupled to the first controller, memory and power up circuitry, wherein, the second controller in response to an indication of a start up condition restricts operation of the first controller and validates the processing instructions, and upon validation of the processing instructions allows a start-up operation of the first controller thereby allowing the first controller to read the processing instructions from the memory.

2. The apparatus of claim 1, wherein the first and second controllers are embedded within a common integrated circuit.

3. The apparatus of claim 1, further comprising a data bus coupled to the second controller, memory and first controller.

4. The apparatus of claim 1, wherein the first controller comprises a reset input, and the second controller comprises an output coupled to the reset input of the first controller.

5. The apparatus of claim 1, wherein the second controller performs validation using public key cryptography.

6. The apparatus of claim 1, wherein the second controller performs validation by checking for watermarks on the processing instructions.

7. The apparatus of claim 1, wherein the second controller decrypts video signals received by the input and then passes the decrypted signals to the decoder.

8. The apparatus of claim 7, wherein the second controller decrypts received video signals using stored keys.

9. A video processing method, comprising:
receiving encoded video signals;
processing the encoded video signals to provide an output signal responsively to a execution of processing instructions;
detecting an indication of a start-up condition;
validating the processing instructions responsively to the detecting; and,
preventing execution of processing instructions until the processing instructions have been validated.

10. The method of claim 9, wherein the validating comprises calculating a checksum.

11. The method of claim 10, wherein the validating further comprises comparing the calculated checksum with a predetermined value.

12. The method of claim 9, wherein the validating comprises accessing a boot sector of the memory.

13. The method of claim 12, wherein the validating further comprises comparing the accessed boot sector to a predetermined boot sector.

14. The method of claim 9, wherein the maintaining comprises activating a reset input of the processor.

15. The method of claim 9, wherein the validating uses public key cryptography.

16. The method of claim 9, wherein the validating comprises checking for watermarks on the processing instructions.

17. The method of claim 9, wherein the processing comprising decrypting the received video signals and then decoding the decrypted signals.

18. The method of claim 9, wherein the decrypting uses at least one stored key.

19. The method of claim 9, wherein the processing occurs in a single integrated circuit.
